(19) United States
(12) Patent Application Publication
(10) Pub. No.: US 2002/0182021 A1
(43) Pub. Date: Dec. 5, 2002

(54) Cutting tool material rod for machining of printed circuit board and method of fabricating the same

(76) Inventor: Ha-Dih Hsieh, HsinChu (TW)

Correspondence Address: BIRCH STEWART KOLASCH & BIRCH, PO BOX 747, FALLS CHURCH, VA, 22040-0747, US

(21) Appl. No.: 09/867,394

(22) Filed: May 31, 2001

(51) Int. Cl. B23B 51/02

(52) U.S. Cl. 408/144; 408/226; 76/108.6; 407/53

(57) ABSTRACT

A cutting tool material rod for machining of printed circuit boards and method of fabricating the same, adapted for recycling worn cutting tools, includes the following process steps: cutting off the edge section of a worn cutting tool to form a base portion, supplementing one end of the base portion to the total desired length, and making the other end of the base section a machining section for forming a new edge section of the recycled cutting tool. The cutting tool thus formed may be used to fabricate drills or routers, for machining printed circuit boards without dimensional limitations.

### FIELD OF THE INVENTION

This invention relates to a cutting tool material rod and method of its fabrication, to produce cutting tools for machining of printed circuit board, and particularly a fabrication process for recycling worn cutting tools and the material rod being made.

### BACKGROUND OF THE INVENTION

The printed circuit board is an essential component for nearly all electronic devices nowadays. With increasing development and popularity of various types of electronic products, the demand for printed circuit boards is also growing. As a result, the consumption of cutting tools used for fabricating the printed circuit board is rapidly increasing as well. The commonly used cutting tools for printed circuit boards are drills and routers for drilling holes or shaping the desired forms. Because of the need for high precision, the machining spinning speed is very fast, usually ranging between 40,000 and 120,000 RPM or higher. Hence, the cutting tools wear out very fast (for instance, a drill is usually discarded after about 10,000 drilling operations).

These types of cutting tools generally have an edge section 11 and a shank 12 (as shown in FIG. 1A). The cutting tool material mainly consists of cobalt-contained tungsten carbide, constructed with extra fine grains for attaining both great strength and toughness. As tungsten carbide is quite expensive, much is required. and it is quickly worn out, recycling the worn cutting tools becomes an important issue. However, the presently available recycling methods still have many drawbacks and are not very practical, thus they are not widely accepted. Hence, most manufacturers simply throw away the worn cutting tools, or give them to waste collectors for recycling and to be made into lower grade products. This is a waste of expensive resources.

Some manufacturers have developed methods for recycling worn cutting tools. One method is to cut off the edge section 11 of the cutting tool 10 (as shown in FIG. 1B), then grind the remaining shank portion 12 to form a round rod 121 of a smaller diameter and shorter length. The rod 121 is then deposited into a snap groove 21 of a sleeve 20 made of stainless steel. The rod 121 is secured in the sleeve 20 by welding or forced coupling, to become another cutting tool (as shown in FIG. 1C).

However, the foregoing recycling method has some disadvantages, notably:

1. The recycled tungsten carbide rod has a smaller diameter and therefore has dimensional limitations as a recycled cutting tool, i.e. the recycled cutting tool cannot exceed the diameter of the recycled rod (otherwise the sleeve might be fractured when coupled and engaged with the cutting tool under force).

2. Only the front end of the cutting tool that has been made with the rod of a smaller diameter consists of tungsten carbide, while the chucking portion is made of stainless steel, which is not as strong. Hence, this recycling method is suitable only for drills (which receive compressive and torsional force), and is not suitable for routers (which receive bending and torsional force).

3. The bonding strength is not sufficient (by the same reason set forth above). The drill portion (tungsten carbide) might become loose or break away during use.

4. The small round rod might be skewed when coupling with the sleeve (as shown in FIG. 1D). While the exposed portion may be shaped straight by machining as a regular drill, the bonding section in the sleeve could still be skewed, resulting in unbalanced coupling and reducing total effectiveness.

### SUMMARY OF THE INVENTION

The primary object of this invention is to resolve the aforesaid disadvantages by providing a cutting tool material rod for machining of printed circuit boards, and a method for fabricating the material rod. Thus we can recycle cutting tools worn out in the process of machining printed circuit boards, and greatly reduce production cost.

The material rod and fabrication method according to this invention is to cut off the edge section of the worn cutting tool, and supplement the rod material to a total length desired to form a cutting tool material rod, which has one end forming a machining section for producing the edge section of the cutting tool. As the machining section has the same external diameter as the original material rod, the recycled cutting tools may have the same dimensions as those made from the original material, without the aforementioned dimensional limitations. Moreover, there is a space on the bonding section and edge section for chucking use. The chucking section includes a portion of tungsten carbide, so there is sufficient chucking strength to support a wider variety of applications. The loosening or breaking away of the drill portion may also be avoided.

The foregoing, as well as additional objects, features and advantages of the present invention will be more readily apparent from the following detailed description, which proceeds with reference to the accompanying drawings.

### BRIEF DESCRIPTION OF THE DRAWINGS

FIGS. 1A-1D are schematic views of a conventional cutting tool recycling method.

FIG. 2 is the recycling process of this invention.

FIGS. 3A and 3B are schematic views of the material rod of this invention.

FIGS. 4A-4E are schematic views of this invention, showing a fastening section coupling with a bonding section.

FIGS. 5A and 5B are schematic side views of a second embodiment of this invention.

FIG. 6 is schematic side view of a third embodiment of this invention.

### DESCRIPTION OF THE PREFERRED EMBODIMENTS

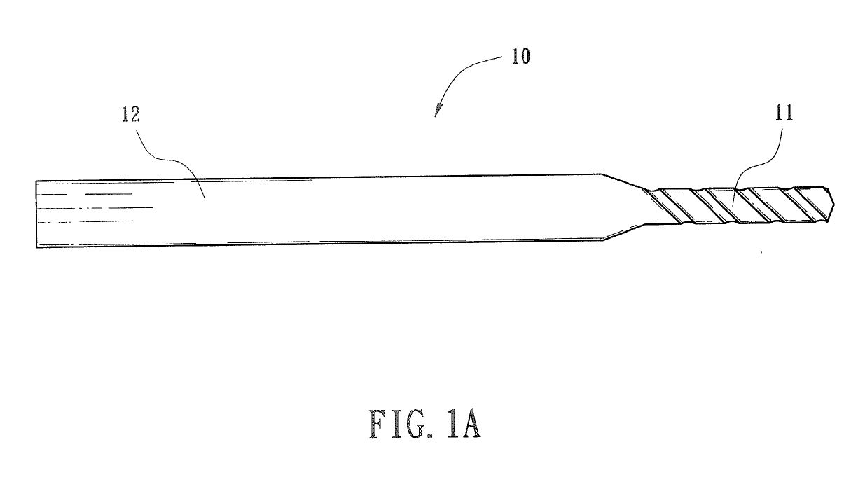

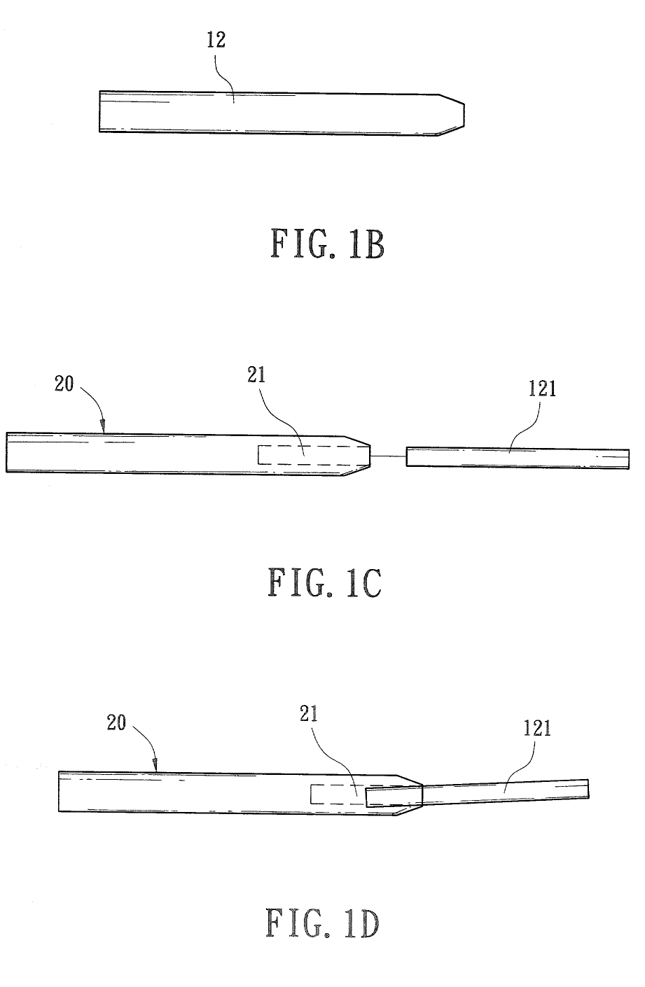

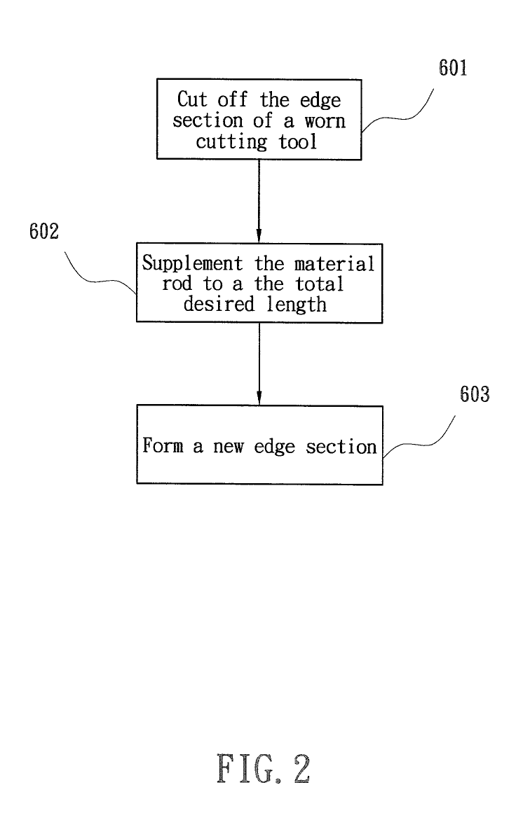

Referring to FIG. 2, the process of fabricating the material rod of the cutting tool comprises the steps of: cutting off the edge section 11 of the worn cutting tool 10 (step 601, also referring to FIG. 1A) to form a base portion 30; supplementing the material rod to a total length desired to form a cutting tool material rod (step 602, for instance, according to the standard specification suggested in IPC-DR-570A, 1994, the length of the cutting tool shall be 1.5 ₋₀₀₁₅⁺⁰⁰⁰⁵ inches); forming a new edge section at the front end, such as a drill bit or an edge section of a router (step 603).

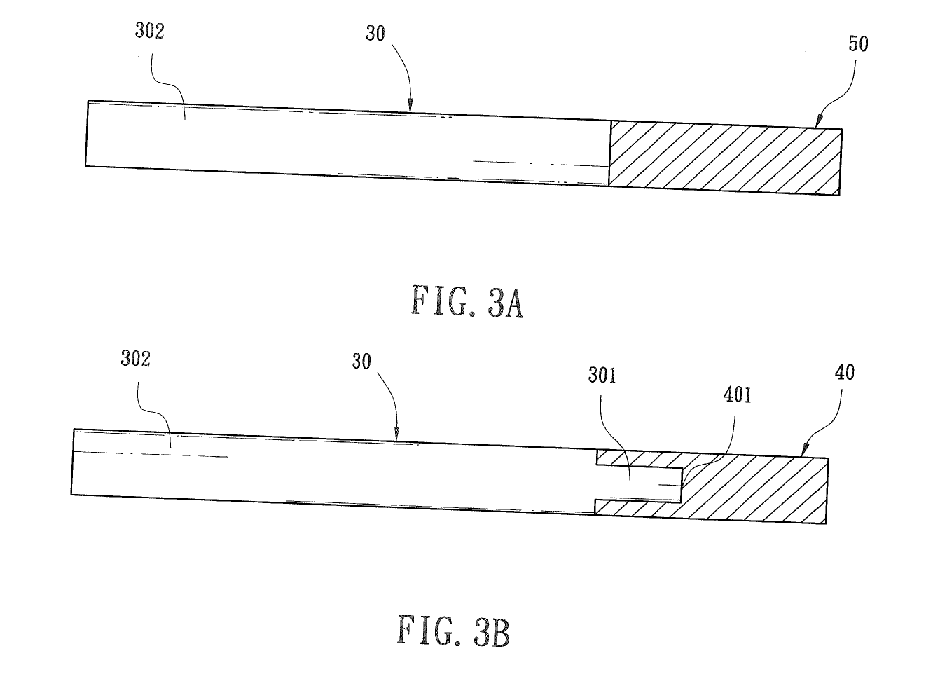

The total length of the material rod may be supplemented by soldering a pad 50 to one end of the base portion 30, while the other end maintains its the original dimensions, then machining to form the edge section (shown in FIG. 3A). Another way is to form a fastening section 301 at one end of the base portion 30 (shown in FIG. 3B) with a smaller diameter than the shank of the original cutting tool 10. The front end (i.e. the other end of the fastening section 301) maintains its original dimensions for machining to form the edge section of new tools. The fastening section 301 is engaged with a sleeve 40 by welding or forced coupling through a bonding section 401 formed in the sleeve 40.

The sleeve 40 and pad 50 may be made of a metal different from the original cutting tool 10, such as stainless steel, which is cheaper and will reduce material costs (of course, tungsten carbide may also be used. but that is more costly). As the edge forming portion (i.e. the front end of the base portion 30) maintains its original dimensions, various types of cutting tool edge sections may be formed by machining, without dimensional limitations. Furthermore, the tungsten carbide portion (i.e. the base portion 30) has sufficient length for chucking use (or including a portion of the tungsten carbide and sleeve 40, as will be described later). The chucking strength will thereby be greatly increased, and will be adaptable to a wide variety of cutting tools such as drills, routers, and the like.

Referring to FIG. 3A, the material rod according to one embodiment of this invention includes a base portion 30 and a pad 50, bonded to the base portion 30 by soldering. The other end of the base portion 30 becomes a machining section 302. Referring to FIG. 3B, the material rod may also include a base portion 30 and a sleeve 40. The base portion 30 has one end forming a machining section 302 and the other end forming a fastening section 301 for engaging with a bonding section 401 formed in the sleeve 40, thereby fastening the sleeve 40 to the base portion 30.

Presently, the best material for the base portion 30 is cobalt-contained tungsten carbide constructed by super fine grains. This may be obtained by recycling and machining worn cutting tools (of course, virgin material may also be used). The sleeve 40 and pad 50 are made of a metal different from the base portion 30, such as stainless steel, which is cheaper and will reduce material costs.

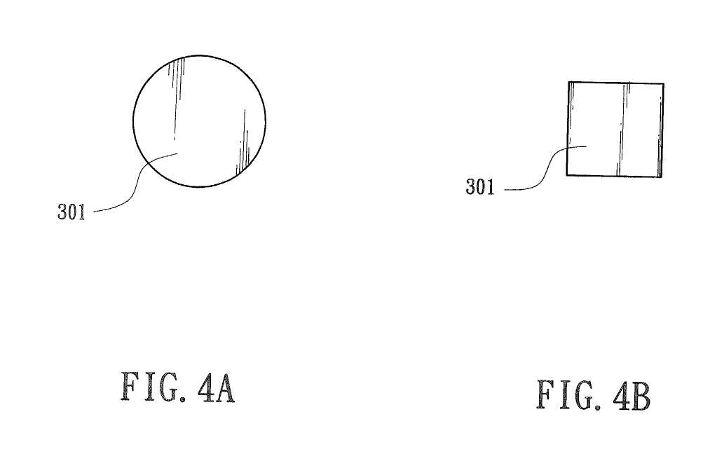

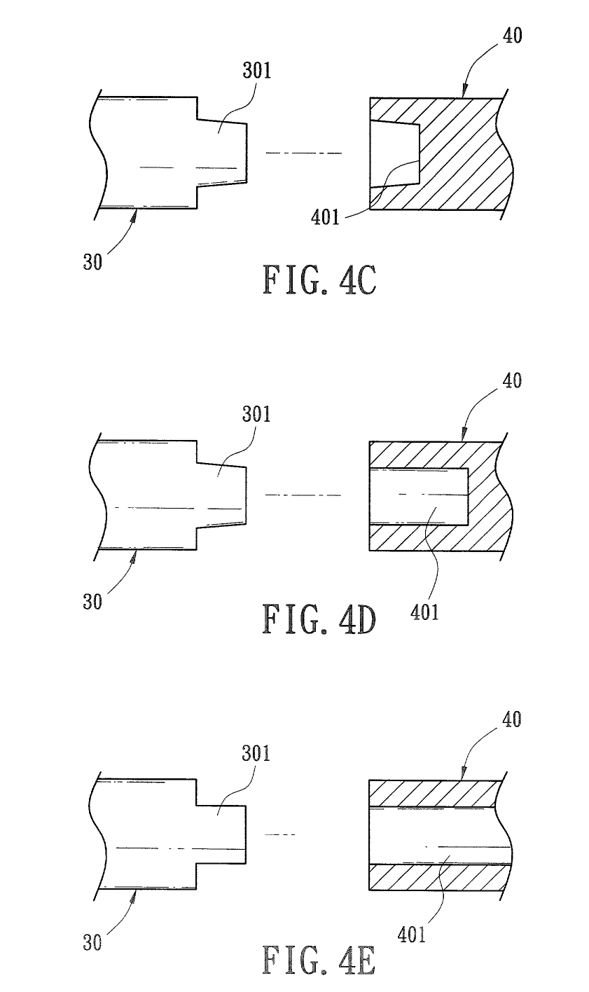

The fastening section 301 of the base portion 30 has smaller dimensions for engaging with the bonding section 401. The cross section of the fastening section 301 may be circular (as shown in FIG. 4A), square (shown in FIG. 4B), or other desired geometric forms. It may also be tapered (shown in FIG. 4C), or in the shape of a circular or square cone (not shown in the drawings) to facilitate bonding to the bonding section 401. The cavity depth of the bonding section 401 may be greater than the length of the fastening section 301 (shown in FIG. 4D), or be open all the way through (shown in FIG. 4E), for securely bonding to the fastening section 301. The bonding method may be welding or forced coupling. These types of bonding methods will produce a greater strength than the conventional methods, which are done by inserting a small round rod, and often result in skewing, axial misalignment, or loosening.

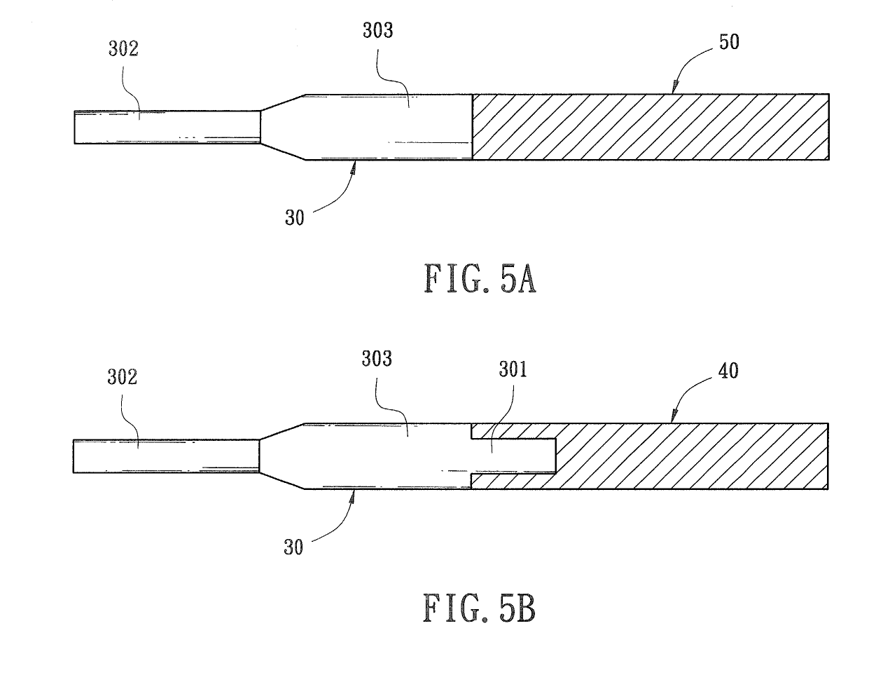

Similarly, the machining section 302 may be fabricated so as to form the edge section of a variety of cutting tools, such as drills, routers, and the like, and still maintain the shank dimensions of the original cutting tools without size limitations. The length of the base portion 30 is determined by the dimensions of the recycled original cutting tools (i.e. for cutting tools with a longer edge section, the recycled length will be shorter). As shown in FIGS. 3A and 3B, when the base portion 30 is relatively long, the chucking portion will be mostly of tungsten carbide and will result in greater chucking strength. Thus it will have no application limitations. Referring to FIGS. 5A and 5B, when the base portion 30 is relatively short, the length of the sleeve 40 or pad 50 shall be increased to attain the required total length. The chucking portion consists of a portion of the tungsten carbide (i.e. the base portion 30), and a portion of the sleeve 40 or pad 50. In other words, the chucking portion is located around the bonding portion of the two. As the chucking portion contains a portion of the tungsten carbide, the recycled cutting tool may thus withstand bending, torsional and compressive force, and will not have application limitations, thus being useful for drills or routers. The machining section 302 may also be prefabricated to a smaller rod diameter to facilitate machining for the edge section. The chucking section 303 is located between the machining section 302 and fastening section 301 for chucking use.

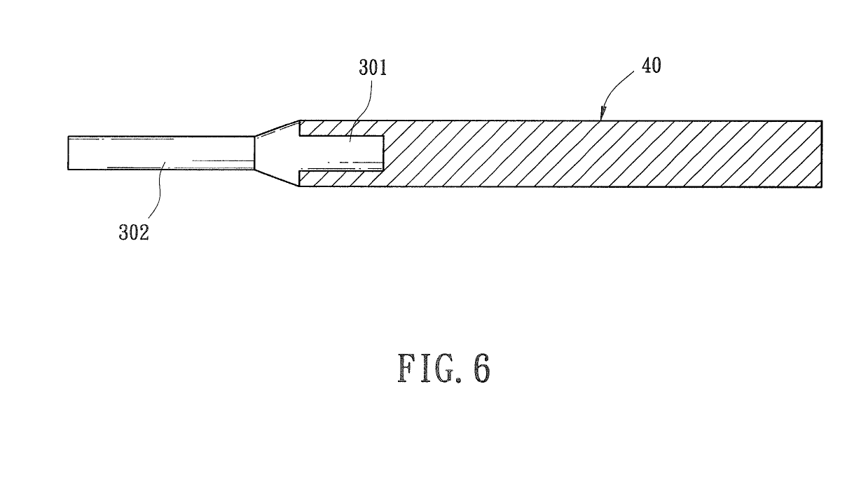

Referring to FIG. 6, when the base portion 30 is extremely short, one piece of the original cutting tool may be recycled to form two sets of base protion(a similar method may be adapted for the pad 50, not shown in the drawing). In other words, the original cutting tool may be cut into two pieces. Such a method may save a lot of material costs. However, the chucking section is located at only the sleeve 40 portion, so it can only be used for drills or smaller sized routers. Nevertheless, the finished dimension still has a wider range than that of the conventional recycling methods.

In summary, the cutting tool recycling method according to this invention has the following advantages:

1. The recycled cutting tools may be adapted to various sizes without dimensional limitations.

2. It can be adapted to various types of cutting tools such as drills, routers, and the like, without application limitations.

3. It has sufficient bonding and chucking strength without risk of fracturing or breaking apart when in use.

While the preferred embodiments of this invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of this invention.

What is claimed is:

1. A method of fabricating cutting tool material rod for machining of printed circuit board to recycle a worn cutting tool, comprising the steps of:
cutting off the edge section of the worn cutting tool to form a base portion; and
supplementing one end of the base portion to attain a total length desired for forming the cutting tool material rod.

2. The method of claim 1 further including a step of forming an edge section at another end of the base portion after the supplementing of the base portion being done.

3. The method of claim 1, wherein the step of supplementing one end of the base portion is done by bonding a pad at the one end of the base portion through soldering.

4. The method of claim 1, wherein the step of supplementing one end of the base portion includes:
forming a fastening section of a smaller dimension at one end of the base portion; and
engaging a sleeve with the fastening section to form the cutting tool material rod.

5. The method of claim 4, wherein the sleeve has an inner cavity for engaging with the fastening section.

6. The method of claim 4, wherein the sleeve engages with the fastening section by welding.

7. The method of claim 4, wherein the sleeve engages with the fastening section by forced coupling.

8. A cutting tool material rod for machining of printed circuit boards, comprising:
a base portion having two ends formed respectively a machining section for fabricating an edge section and a fastening section which has a smaller dimension; and
a sleeve having one end formed a bonding section to engage with the fastening section for bonding the sleeve to the machining section.

9. The cutting tool material rod of claim 8, wherein the base portion further has a chucking section located between the machining section and fastening section.

10. The cutting tool material rod of claim 8, wherein the fastening section is cylindrical and the bonding section of the sleeve is a cavity engageable with the fastening section.

11. The cutting tool material rod of claim 10, wherein the fastening section is tapered.

12. The cutting tool material rod of claim 10, wherein the bonding section is a through circular opening.

13. The cutting tool material rod of claim 8, wherein the fastening section is a square strut and the bonding section of the sleeve is a square cavity engageable with the fastening section.

14. The cutting tool material rod of claim 8, wherein the bonding section is a through square opening.

15. The cutting tool material rod of claim 8, wherein the machining section is for forming cutting edges of a drill.

16. The cutting tool material rod of claim 8, wherein the machining section is for forming cutting edges of a router.
